(19) United States
(12) Patent Application Publication
(10) Pub. No.: US 2003/0127860 A1
(43) Pub. Date: Jul. 10, 2003

(54) Recirculating hydroelectric power generation system

(76) Inventor: Stuart Louis Baron, Cayucos, CA (US)

Correspondence Address: Stuart L. Baron, 2702 Richard, Gayucos, CA, 93430, US

(21) Appl. No.: 10/280,690

(22) Filed: Oct. 25, 2002

Related U.S. Application Data
(60) Provisional application No. 60/346,400, filed on Jan. 4, 2002.

(51) Int. Cl. H02P 9/04; F03B 13/00; F03B 13/10

(52) U.S. Cl. 290/43

(57) ABSTRACT

A Recirculating Hydroelectric Power Generation System is disclosed. The system includes a reservoir and at least one confinement column connected, and open to the reservoir at the base of the at least one confinement column. A source of pressurized air is provided and means for delivering the air to an air diffuser located near the base of the at least one confinement column. A guide chute is located at the top of the at least one confinement column in such a way that water exiting the top of the at least one confinement column is directed to a waterwheel or turbine, said waterwheel or turbine being operably connected to an electric generator unit.

### CROSS-REFERENCE TO RELATED APPLICATION

This U.S. Patent Application is based upon U.S. Provisional Patent Application Ser. No. 60/346,400 filed Jan. 4, 2002, entitled “RECIRCULATING HYDROELECTRIC POWER GENERATION SYSTEM”.

### FEDERALLY SPONSORED RESEARCH

Not applicable

### SEQUENCE LISTING OR PROGRAM

Not applicable

### BACKROUND OF THE INVENTION

There appears to be no backround relating to this specific invention. The present invention appears to be the first to employ gas injection into a liquid to directly produce a flow of the liquid in order to induce rotation of a wheel or turbine.

This invention fits loosely into the category of hydroelectric power production.

### BACKROUND OF THE INVENTION—OBJECTS AND ADVANTAGES

Several objects and advantages of the present invention are:

(a) generating electricity without burning any fuel, thus contributing to a reduction of air pollution;

(b) generating electricity without using nuclear fuels, thus contributing to a reduction of the problem of disposal of nuclear waste;

(c) generating electricity at a rate per unit of area far greater than can ever be attained by photovoltaic systems;

(d) generating electricity at a cost of production that is far less than that of fossil fuel or nuclear generating plants;

(e) making feasible the use of simple all electric vehicles by making the source of the recharging electricity both inexpensive and non-polluting;

(f) providing a non-polluting source of electricity that will eventually replace virtually all fossil fuel and nuclear plants;

(g) generating electricity without the negative environmental impacts that ususally accompany other non-polluting electrical generation systems such as wind power [visual impacts], conventional hydroelectric [altering natural watercourses, often to the detriment of fish and other wildlife], and photovoltaic [large areas required for substantial output];.

(h) provision of a system for generating electricity for remote locations, that is both less expensive and more reliable than photovoltaic systems, and that does not contribute to air pollution as would most fossil fuel electric generators; and

(i) providing the possibility of returning some existing hydroelectric locations to their natural states by providing a non-polluting alternative method of generating electricity.

Still further objects and advantages will become apparent from a consideration of the ensuing description and drawings.

### SUMMARY

In accordance with the present invention, a recirculating hydroelectric power generation system comprises a reservoir with a confinement column and guide chute, a wheel or turbine operably connected to a generator. The wheel or turbine is situated above the reservoir. A source of pressurized air and means for delivering said air into the base of the confinement column are also provided.

### DRAWINGS—FIGURES

FIG. 1 shows a cross-section of the system in a natural reservoir. The wavy horizontal line represents the correct water level.

FIG. 2 is a front or rear elevation showing one preferred relationship of the wheel to the generator.

FIG. 3 shows a cross-section of a preferred embodiment where the reservoir is manmade and the air source is mounted above the correct water level which is indicated by the wavy horizontal line.

FIG. 4 shows a preferred embodiment in which the air source is located below the water level in the reservoir and in which a plenum is incorporated for air pressure control. The correct water level is indicated by the wavy horizontal line.

FIG. 5 is a plan view of a preferred embodiment in which multiple generating systems are operated from a single air source.

FIG. 6 shows a cross-section of an integrated wheel/generator.

### DRAWINGS—REFERENCE NUMERALS

10 reservoir

12 confinement column

14 source of pressurized air

16 means for delivering pressurized air to bottom of confinement column

18 guide chute

20 means for converting kinetic energy of water into rotational energy

22 means for converting rotational energy into electrical energy

24 means to accererate water by cross section restriction

26 float valve

28 air diffusion means

30 backflow prevention means

32 air pressure regulation means

34 axle of waterwheel and generator

36 magnets

38 air gap

40 stationary rotor

42 windings

### DETAILED DESCRIPTION—FIGS 1 AND 3—PREFERRED EMBODIMENTS

Two preferred embodiments of the present invention are illustrated in FIG. 1 and FIG. 3. FIG. 1 shows a cross-section of a preferred embodiment which uses a natural body of water as the reservoir. The invention comprises reservoir 10, confinement column 12 which is connected and open to reservoir 10 at the lower end of column 12, a source of pressurized air 14, a means for delivering pressurized air means 16 to the lower end of confinement column 12, an air diffusion means 28, a guide chute 18, a means for converting kinetic energy of the water into rotational energy means 20, and a means for converting rotational energy into electrical energy (not shown).

FIG. 3 is the same as FIG. 1 except that the reservoir 10 is manmade and confinement column 12 is part of reservoir 10.

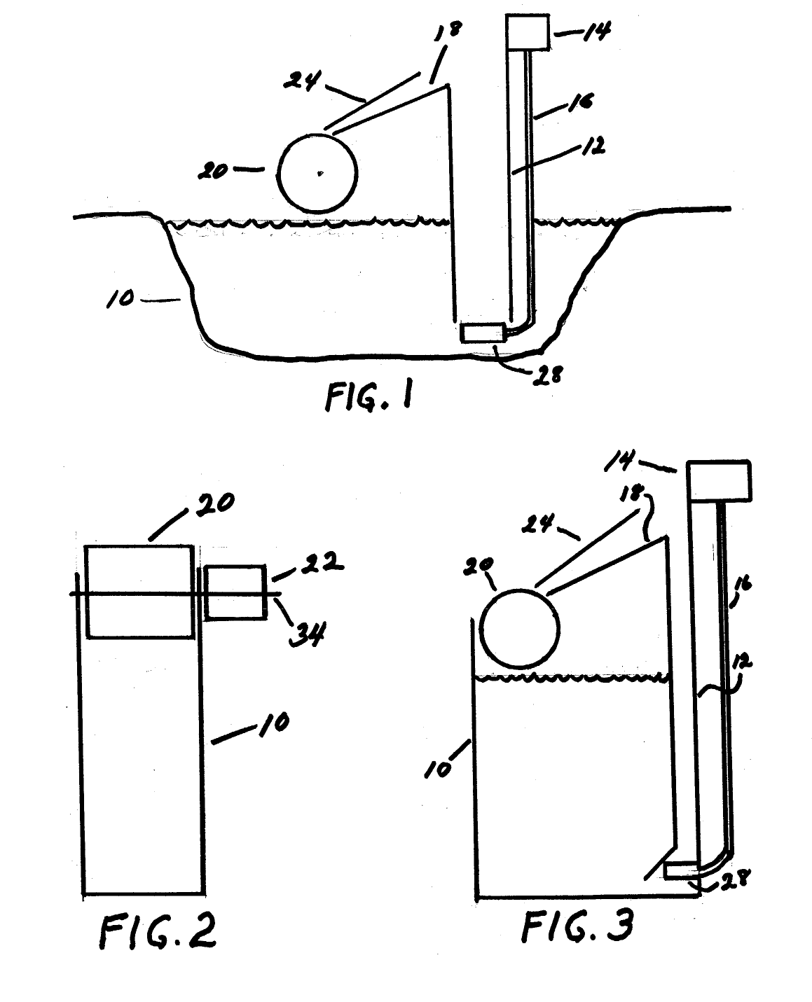

FIG. 2 shows a front or rear view of the system in which reservoir 10 is manmade and means for converting kinetic energy of water into rotational energy means 20 is directly connected to means for converting rotational energy to electrical energy 22 through axle of waterwheel and generator 34.

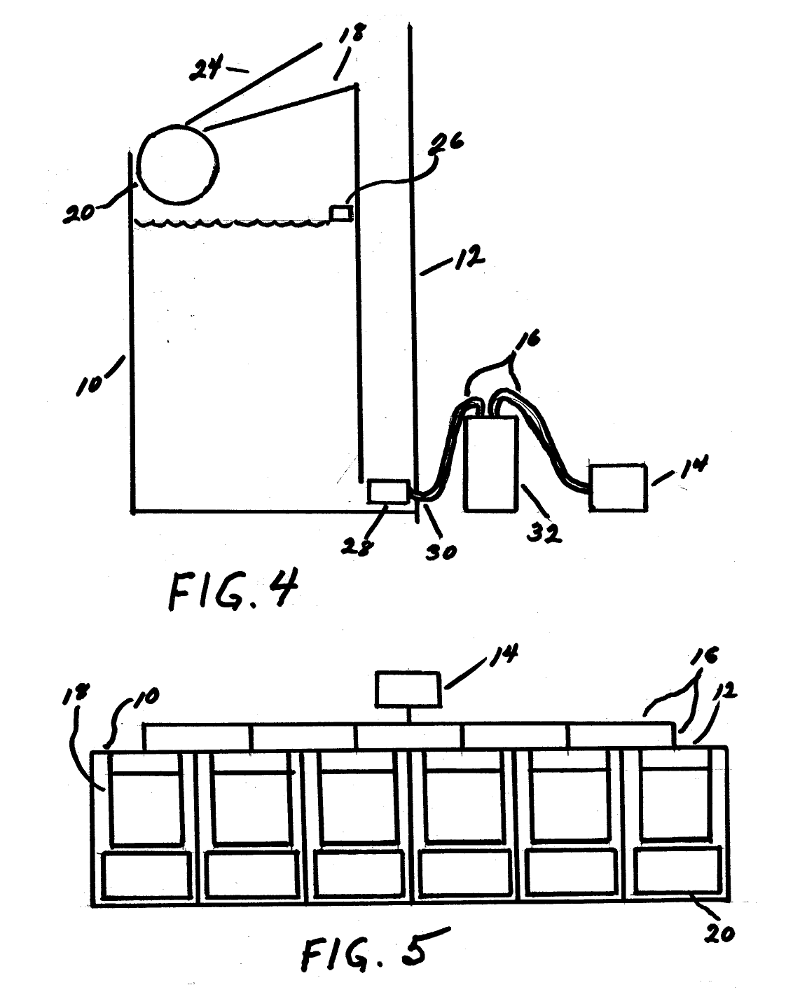

FIG. 4 is a cross-section of a preferred embodiment similar to that shown in FIG. 3, but with the pressurized air source 14 located below the water level in reservoir 10. In this embodiment, a backflow prevention means 30 is required. This embodiment also is shown having air pressure regulation means 32.

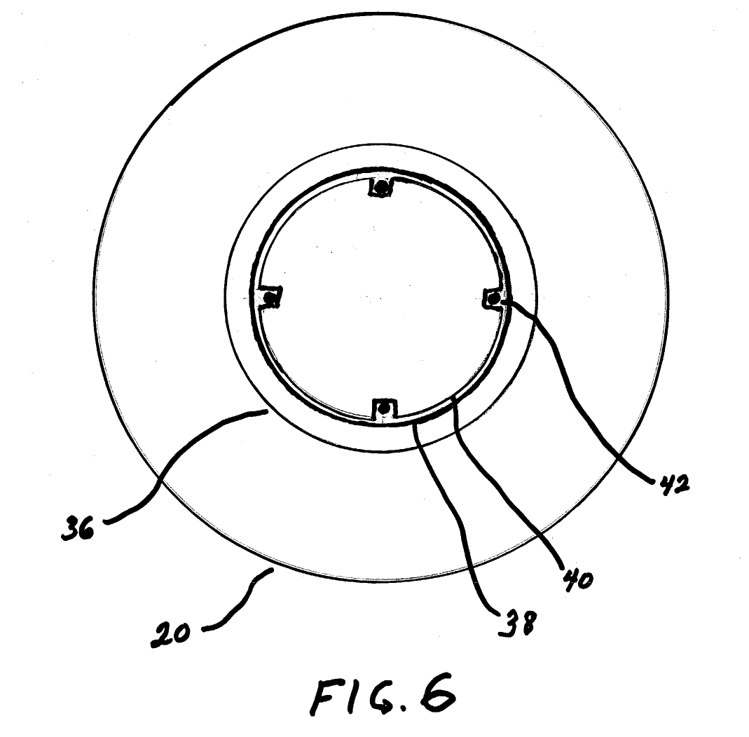

FIG. 5 is a plan view of a currently preferred embodiment in which a single source of pressurized air 14 is used to operate multiple electric power generating assemblies. A single reservoir 10 is provided. Means for delivering pressurized air 16 is split.

FIG. 6 is a cross-section of an integrated wheel and generator comprising means for converting kinetic energy of water into rotational energy 20, magnets 36 attached to the inside of means 20, stationary rotor 40 having windings 42, and a small air gap 38.

Additional Embodiments

There are numerous additional embodiments possible which utilize the basic principal of the current invention, namely the use of pressurized air injection into a liquid in order to induce a flow of the liquid to spin a wheel or turbine in order to produce useful work, in particular to produce electricity.

In principal, liquids other than water and gases other than air can be utilized in the current invention, however, all currently preferred embodiments utilize water as the liquid and air as the gas.

All currently preferred embodiments include an air diffusion means 28.

Operation

The system operates as follows:

The reservoir is first filled with water to the proper level which is just below the lowest part of the waterwheel or turbine. The purpose is to keep the wheel above the reservoir water level in order to reduce drag on the wheel or turbine.

The pressurized air source is turned on. As soon as enough air pressure builds up to overcome the water pressure at the air injection point at the base of the confinement column, bubbles begin emerging from the air diffuser. As these bubbles emerge, they displace the water in the confinement column. The displacement forces the unbubbled water above to rise until the top of confinement column is reached. The water at the top of the confinement column spills over into the guide chute. When all of the non-bubbled water has spilled into the guide chute, the system goes into a phase change to a rapid and essentially stable and even flow. The water rotates the waterwheel or turbine which is connected to a generator which spins, thus producing electricity. That electricity can be direct current or alternating current and can be conditioned for the desired application.

Theory of Operation

The system operates as described above by virtue of the fact that injecting air into the water in the confinement column makes that water weigh less per unit of volume than the water in the reservoir. Gravity thus forces the water in the confinement column to rise resulting in the flow. The confinement column is open at the top for two reasons. First, being open allows most of the entrapped air to escape before the water reaches the wheel or turbine. This helps minimize cavitation which can cause premature wear of the wheel or turbine. Second, having the top of the confinement column and part of the guide chute open allows atmospheric pressure to increase the velocity of the water flow through the guide chute. This is important because the controlling formula is: Kinetic Energy=½ mass×velocity².

In practice, the smaller the bubbles, the smoother the operation.

Conclusion, Ramifications, and Scope

Accordingly, the reader will see how that this invention provides a clean, simple, and inexpensive way of generating electricity. The invention utilizes abundant and inexhaustible resources, namely water, air, gravity, and atmospheric pressure which is a manifestation of gravity,

I claim:

1. A recirculating hydroelectric power generation system comprising: a reservoir, at least one confinement column, said at least one confinement column being connected, and open to said reservoir at the bottom of said at least one confinement column; a source of pressurized air, and means for delivering said pressurized air into the bottom of said at least one confinement column; a means for directing a resulting flow of water to a means for converting said flow of water into rotational energy; and a means for converting said rotational energy into electrical energy;
said reservoir may be natural, or manmade;
said source of pressurized air is chosen from that group of devices that includes fans, blowers, compressors, the compression portion of turbochargers, and the compression portion of superchargers;
said means for converting the flow of water into rotational energy is chosen from that group of devices that includes waterwheels, turbines, and Pelton wheels;
said means for converting rotational energy into electrical energy is chosen from that group of devices which includes electric generators, electric alternators, and dynamos.

2. The recirculating hydroelectric power generation system according to claim 1. with the addition of a means for diffusing said pressurized air as said pressurized air is delivered into the water at the base of said at least one confinement column; said means for diffusing said pressurized air is chosen from that group of devices that includes air stones, aeration hoses, aeration units, gas diffusers, and air diffusers.

3. The recirculating hydroelectric power generation system according to claim 1. with the addition of at least one means for preventing backflow of water into said pressurized air means when the system is not in operation; said at least one means for preventing backflow is chosen from that group of devices that includes check valves, needle valves, and backflow prevention valves.

4. The recirculating hydroelectric power generation system according to claim 1. with the addition of a means for regulating air pressure to the water at the base of said at least one confinement column; said means for regulating air pressure is chosen from that group of devices that includes pressure regulating valves, and plenum creating devices.

5. The recirculating hydroelectric power generation system according to claim 1. in which said means for converting the flow of water into rotational energy is a waterwheel which also constitutes said means for converting said rotational energy into electrical energy; said waterwheel has permanent magnets, or electromagnets; a stationary rotor occupies the axis of rotation of said waterwheel, and has windings of some electrically conductive material.

6. The recirculating hydroelectric power generation system according to claim 1. with the addition of a means for maintaining the proper level of water within the system to compensate for evaporation losses; said means is chosen from that group that includes float valves.

7. The recirculating hydroelectric power generation system according to claim 1. in which said at least one confinement column is an integral part of said reservoir.

8. The recirculating hydroelectric power generation system according to claim 1. in which said means for directing the flow of water is a guide chute, said guide chute having at least one means for accelerating said flow of water by restricting the cross-sectional area of said guide chute.

9. The recirculating hydroelectric power generation system according to claim 1. in which said at least one confinement column, and said guide chute are a unitary construct.

10. The recirculating hydroelectric power generation system according to claim 1 with the addition of an air diffuser means, and the addition of water purification means; said water purification means are chosen from that class of systems which includes biological filters, and mechanical filters; this claim describes the system used in conjunction with a fish farming operation, and integral with said fish farming operation.
